(19) United States
(12) Patent Application Publication
(10) Pub. No.: US 2025/0248877 A1
(43) Pub. Date: Aug. 7, 2025

(54) STAIR BARRIER SYSTEM

(71) Applicant: Mark Anderson, Williamsburg, VA (US)

(72) Inventor: Mark Anderson, Williamsburg, VA (US)

(21) Appl. No.: 18/435,670

(22) Filed: Feb. 7, 2024

(51) Int. Cl. A61H 3/00

(52) U.S. Cl. CPC A61H 3/00; A61H 2003/001; A61H 2201/0107; A61H 2201/0126; A61H 2201/169

(57) ABSTRACT

Systems, apparatus, articles of manufacture, and methods are disclosed for a stair barrier system configured for positioning on a staircase. An example stair barrier system includes first and second barriers, each barrier having a body portion, a base portion, and an adjustable member, wherein the adjustable member is adapted to exert a force on a side surface perpendicular to the staircase. Each body portion has a body height greater than a body width, wherein each base portion includes a first end and a second end and has a base width greater than the body width. The body portion of the first barrier is above the first end of the base portion, and wherein the body portion of the second barrier is above the second end of the base portion.

### FIELD OF THE DISCLOSURE

The present invention generally relates to safety while ascending and descending stairs. More specifically, the present invention relates to a stair barrier system that improves safety while ascending and descending stairs by preventing falling down multiple stairs.

### BACKGROUND

Millions of Americans sustain injuries requiring medical treatment from accidental falls every year. The highest risk groups for these injuries are young children and elderly adults. Many of these individuals live in homes with steep staircases and tall stairs, which could lead to more serious injuries for these already at-risk individuals.

Barrier systems that provide safety while ascending and descending stairs are generally known. For example, one example safety system includes barriers extending across a portion of a staircase and staggered in an alternating manner from opposite sides and spaced apart to permit direct travel up or down stairs. While these barriers prevents a person from tumbling to the bottom of the stairs, the wall-mounted barriers pivot along a vertical axis between an operable position and an inoperable position. Another example safety system includes a protective barrier for a stairway that has a yieldable core that attaches to a riser of the staircase and yields to the weight of a person if the barrier blocks the person from falling. Another example safety feature includes a barrier that extends from a railing adjacent to the stairs to act as an instant barrier to stop a person from falling if they have lost their grip on a set of stairs.

The examples described above present practical problems that must be overcome. A significant issue with the existing stair barrier systems is that they require mounting to stairs, walls, or both. For example, the pivotably mounted barriers mounted to both a stair and a wall require such mounting. In another example, the barriers with a yieldable core mounted to a top surface of one stair and a vertical surface of a sequential stair require such mounting. While mounting effectively secures the known barriers, it takes time and a number of tools. Moreover, mounting the known barriers damages the existing surfaces and structures used for attachment. Removing the known barriers also takes time and a number of tools while damage remains to the surfaces and structure after removal.

Therefore, there exists a need for a stair barrier system to improve safety while ascending and descending stairs that is simple and efficient to install and remove. There also exists a need for such a barrier system that causes less damage to the surfaces and structures of the surrounding stairs and walls.

### SUMMARY OF THE INVENTION

The present disclosure provides a stair barrier system to improve safety while ascending and descending a staircase that is simple and efficient to install and remove. In one embodiment, the stair barrier system of the present application includes first and second barriers, each barrier having a body portion, a base portion, and an adjustable member, wherein the adjustable member is adapted to exert a force on a side surface perpendicular to the staircase. Each body portion has a body height greater than a body width, wherein each base portion includes a first end and a second end and has a base width greater than the body width. The body portion of the first barrier is above the first end of the base portion, and wherein the body portion of the second barrier is above the second end of the base portion.

One object of the present invention is to provide a stair barrier system that improves safety while ascending and descending stairs by preventing falling down multiple stairs. Another object of the present invention is to provide a stair barrier system comprising a plurality of barriers staggered in an alternating manner on a plurality of stairs. The plurality of barriers is installed and removed easily without causing significant damage to surfaces and structures of the plurality of stairs and surrounding walls.

Additional objects and advantages of the present invention will be apparent to those skilled in the art from the invention's description, taken in conjunction with the attached drawings.

### BRIEF DESCRIPTION OF THE DRAWINGS

FIG. 1 is a first stair barrier system to improve safety while ascending and descending stairs.

FIG. 2 illustrates a front view of a barrier of the first stair barrier system of FIG. 1.

FIGS. 3 and 4 illustrate perspective views of a barrier of the first stair barrier system of FIG. 1.

FIG. 5 is a second stair barrier system to improve safety while ascending and descending stairs.

FIGS. 6 and 7 illustrate perspective views of a barrier of the second stair barrier system of FIG. 5.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

While the present invention is susceptible of embodiments in various forms, there is shown in the drawings and will hereinafter be described certain exemplary and non-limiting embodiments, with the understanding that the present disclosure is to be considered an exemplification for the invention and is not intended to limit the invention to the specific embodiments illustrated. In this disclosure, the use of the disjunctive is intended to include the conjunctive. The use of the definite article or indefinite article is not intended to indicate cardinality. In particular, a reference to “the” object or “a” object is intended to denote also one of a possible plurality of such objects. Also, throughout the description, a user is referenced as a male by using the pronouns “he” or “his”. Use of male pronouns to describe a user is for convenience only as the user can be either male or female.

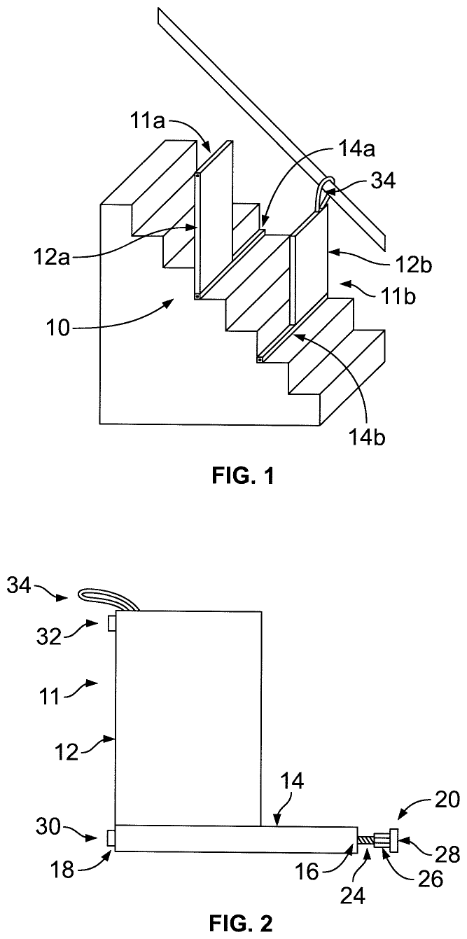

FIG. 1 is an example stair barrier system 10 to improve safety while ascending and descending stairs by preventing falling down multiple stairs. In FIG. 1, the example first stair barrier system 10 comprises an example first barrier 11a and an example second barrier 11b. The example first barrier 11a and the example second barrier 11b are staggered in an alternating manner on a staircase. In some examples, each barrier 11a, 11b has body portion 12a, 12b having a body width less than a width of the stairs. The body portion 12a, 12b of the barrier 11a, 11b operates to block the user falling down the stairs during use. While the stair barrier system 10 illustrated herein include two barriers 11, the stair barrier system 10 may include one barrier 11 or more than two barriers 11.

Each of the first and second body portions 12a, 12b has an attachment configuration 34 that attaches to a rail adjacent to the stairway in order to secure the barrier in a vertical position. FIG. 1 shows the securing member 34 on the second barrier 11b next to an illustrated rail. However, an example second securing member may also be included in the example first barrier 11a, where the first barrier 11a is additionally situated next to a second rail or other suitable structure. In FIG. 1, the example securing member 34 is located at an upper right corner of the example second barrier 11b. However, the example securing member 34 may be located at any upper portion of the example second barrier 11b. In some examples, the securing member 34 is located along the length of the example second barrier 11b. For example, the securing member 34 is adapted to attach to the rail from the body portion 11b of the second barrier 12b. In some examples, the securing member 34 is a means for securing that is adapted to secure to a rail, such as a cord, cable tie, wire, or a hook and loop strap system (e.g., Velcro® strap).

In FIG. 1, the example first and second body portions 12a, 12b are connected to first base 14a and second base 14b, respectively. The example first base 14a and the example second base 14b are referred to herein, collectively, as an example base 14. The example first body portion 12a and the example second body portion 12b are referred to herein, collectively, as an example body portion 12. In some examples, the base 14 has a base width greater than a body width of the body portion 12, but less than the width of the stairs. For example, the first base 14a has a base width greater than a body width of the first body portion 12a and the second base 14b has a base width greater than a body width of the second body portion 12b.

In the illustrated embodiments, the example base 14 of the barriers 11 does not extend along the entire width of a stair. The base 14 extends along the majority of the width of the stair and includes an extending member 20 (FIG. 2) described below that enables the barrier 11 to accommodate various stair widths.

The example body portions 12a, 12b and the example bases 14a, 14b may be made of wood, metal, or any other suitable material. For example, the material of the body portions 12a, 12b and the bases 14a, 14b may be of a specific strength and weight in order to prevent a person from knocking it over and/or passing through it.

In some examples, the body portions 12a, 12b and respective bases 14a, 14b are used together as a pair. For example, a body portion 12a, 12b blocks about one half of a width of stairs on a staircase and are positioned on the stairway, at least one stair apart, positioned at opposing ends of the neighboring stairs, with the body portions 12a, 12b together blocking both halves of the stairway. Additionally and/or alternatively, the example barriers 11a, 11b may be used individually. For example, an individual barrier 11 may be used to block only one half of the stairway, rather than both halves.

FIG. 2 illustrates a front view of the example first barrier 11a or the example second barrier 11b of the example stair barrier system 10. For example, the illustration of FIG. 2 is a front view of either one of the example barriers 11a, 11b. As used herein out, the first and/or second barriers 11a, 11b are referred to as the example barrier 11. In some examples, the barrier 11 has an example extending configuration 20 to exert a force on a pair of opposite surfaces perpendicular to the stairs.

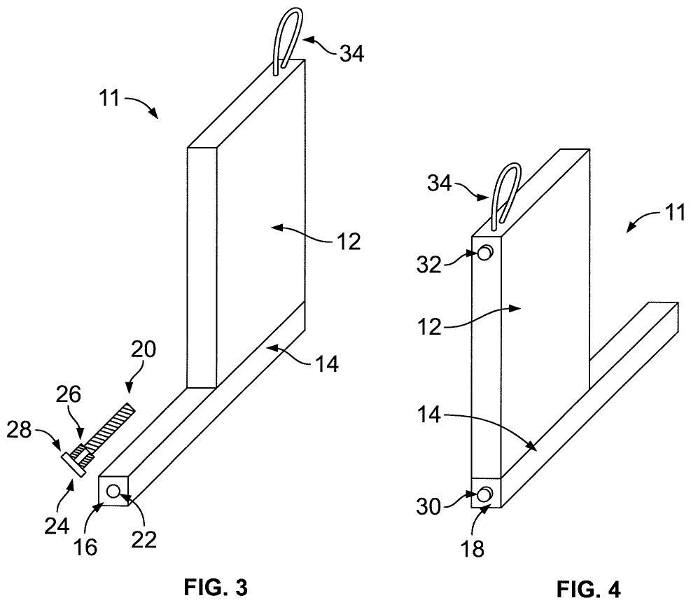

In FIG. 2, the example the extending member 20 is located at a first end 16 of the base 14, the first end 16 distal from the example body portion 12. In FIG. 2, the example extending member 20 includes an example threaded aperture 22 (illustrated in FIG. 3 and described below in connection with FIG. 3) and an example threaded bolt 24. Additionally and/or alternatively, the example extending member 20 includes a spring, a hydraulic cylinder, or any mechanism that can be configured to extended between a pair of opposite surfaces. In some examples, the extending member 20 is referred to as an adjustable member. In FIG. 2, the opposite surfaces are the first end 16 and a wall perpendicular to the stairs. In some examples, the extending member 20 is an example means for extending that is adapted to exert a force on the pair of opposite surfaces perpendicular to the stairs.

FIG. 3 illustrates a first perspective view of the example barrier 11 of the example stair barrier system 10. The first perspective view of FIG. 3 illustrates the example threaded aperture 22 adapted to receive the example threaded bolt 24 that has an example bolthead 26. The example threaded aperture 22 is in the example base 14 at the first end 16. The example threaded aperture 22 removably receives the example threaded bolt 24 that has the bolthead 26. The example bolthead 26 has an example bolthead bumper 28. In some examples, the bolthead bumper 28 is a rubber bumper and abuts the surface perpendicular to the stairs. For example, the bolthead bumper 28 prevents the extending member 20 from damaging the surface that it abuts. In some examples, the bolthead bumper 28 is affixed to the bolthead 26 via any fastening mechanism (e.g., nail, glue, epoxy, paste, etc.).

FIG. 4 illustrates a second perspective view of the example barrier 11 of the example stair barrier system 10. The second perspective view of FIG. 4 illustrates a second end 18 of the base 14, the second end 18 proximate to the body portion 12. The second end 18 of the base 14 includes a first bumper 30. In some examples, the first bumper 30 abuts an opposite surface relative to the surface that the bolthead bumper 28 abuts. In some examples, the first bumper 30 is a rubber bumper to prevent any damage the base 14 may cause on the opposite surface. Additionally and/or alternatively, the first bumper 30 may be made of any material that can protect a surface (e.g., a wall, glass, etc.) from scratches, holes, or any type of damage. The example first bumper 30 is affixed to the example base 14 via any fastening mechanism (e.g., nail, glue, epoxy, paste, etc.).

In FIG. 4, the example barrier 11 includes a second bumper 32. In this example, the second bumper 32 is an upper bumper affixed on an upper portion of the body portion 12. In some examples, the second bumper 32 is directly above first bumper 30. The example second bumper 32 is a rubber bumper to prevent any damage the body portion 12 may cause on the opposite surface. Additionally and/or alternatively, the second bumper 32 may be made of any material that can protect a surface (e.g., a wall, glass, etc.) from scratches, holes, or any type of damage. The example second bumper 32 is affixed to the body portion 12 via any fastening mechanism (e.g., nail, glue, epoxy, paste, etc.).

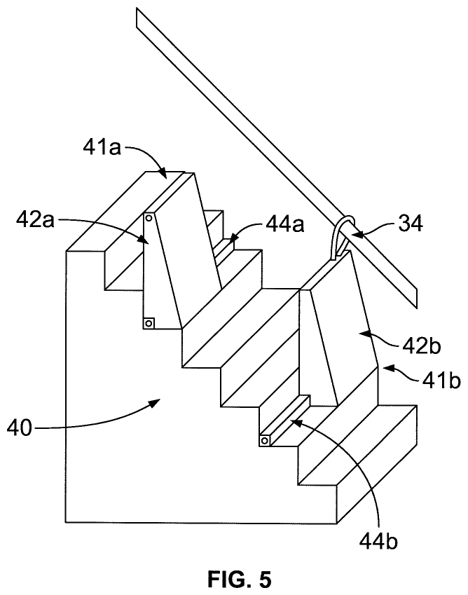

FIG. 5 is an example second stair barrier system 40 to improve safety while ascending and descending stairs by preventing falling down multiple stairs. In FIG. 5, the example second stair barrier system 40 includes an example third barrier 41a and an example fourth barrier 41b. The example third barrier 41a and the example fourth barrier 41b are staggered in an alternating manner on a plurality of stairs. The barriers 41a, 41b include a body portion 42a, 42b and a base portion 44a, 44b. In some examples, the third body portion 42a and the fourth body portion 42b have a width less than a width of the stairs. The example third body portion 42a and the example fourth body portion 42b have the shape of a wedge. For example, the third body portion 42a and the fourth body portion 42b includes a front surface with an inclined plane tapering in an upwards direction and a back surface with a vertical plane. The front surface and the back surface form the wedge shape, with the widest portion at the bottom thereof.

In FIG. 5, the example second barrier system 40 includes the example third base portion 44a and an example fourth base portion 44b. The example third base 44a is connected to the example third body portion 42a and the example fourth base portion 44b is connected to the example fourth body portion 42b. The example third base 44a and the example fourth base 44b are referred to herein, collectively, as an example base 44. The example third body portion 42a and the example fourth body portion 42b are referred to herein, collectively, as an example body portion 42. In some examples, the base 44 has a width greater than a width of the body portion 42, but less than the width of the stairs. For example, the third base 44a has a width greater than a width of the third body portion 42a and the fourth base 44b has a width greater than a width of the fourth body portion 42b. In some examples, the third base 44a and the example fourth base 44b are stabilizing bars to stabilize the third barrier 41a and fourth barrier 41b, respectively.

In some examples, the body portion 42a, 42b and respective bases 44a, 44b are used together as a pair. For example, the body portion 42a, 42b blocks one half of a width of stairs on a stairway and are positioned on the stairway, at least one stair apart, facing in opposition directions, with the pair of body portions 42a, 42b blocking both halves of the stairway. Additionally and/or alternatively, the example body portions 42a, 42b and example respective bases 44a, 44b may be used individually. For example, an individual barrier and base may be used to block only one half of the stairway, rather than both halves.

The example third and fourth body portions 42a, 42b and the example third and fourth bases 44a, 44b may be made of wood, metal, or any other suitable material. For example, the material of the third and fourth body portions 42a, 42b and the third and fourth bases 44a, 44b are a specific strength and weight in order to prevent a person from moving the third and fourth barriers 41a, 41b (e.g., knocking it over, passing through it, etc.). The wedge shape of the example third and fourth body portions 42a, 42b provide additional strength to prevent a person from moving third and fourth barriers 41a, 41b (e.g., knocking it over, passing through it, etc.). For example, the wedge shape of the example body portion 42 increases the strength of the barrier 41 by transferring forward force to downward force, with the body portion 42 rotating on the base 44.

In FIG. 5, the example barrier 42 includes the example securing member 34 that is adapted to attach to rail of a stairway. In FIG. 5, the example fourth barrier 41b includes the example securing member 34 because the example fourth barrier 41b is situated next to an illustrated rail. However, the example third barrier 41a may include the securing member 34, where the third barrier 41a is additionally situated next to a second rail.

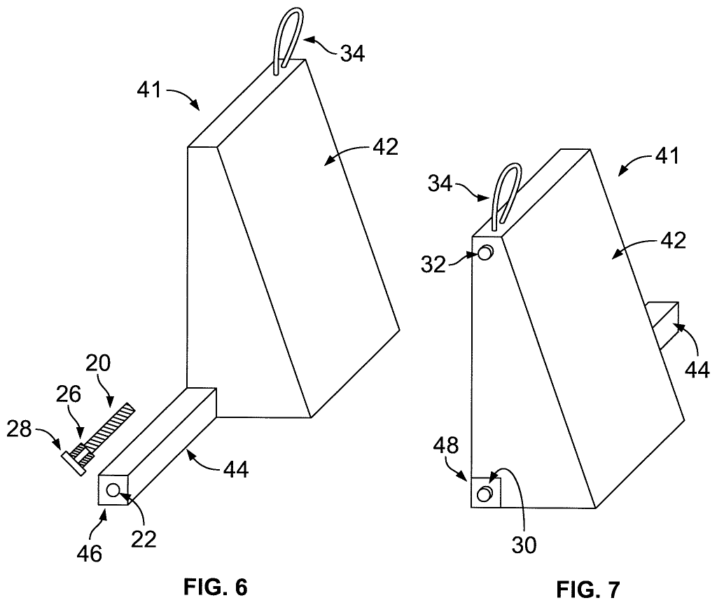

FIG. 6 illustrates a first perspective view of the example barrier 41 of the example second stair barrier system 40. The first perspective view of FIG. 3 illustrates the example extending member 20 to exert a force on a pair of opposite surfaces perpendicular to the stairs. In FIG. 6, the example the extending member 20 is located at a third end 46 of the base 44, the third end 46 distal from the example body portion 42. In FIG. 6, the example extending member 20 includes the example threaded aperture 22 and an example threaded bolt 24. Additionally and/or alternatively, the example extending member 20 includes a spring, a hydraulic cylinder, or any mechanism that can be configured to extended between a pair of opposite surfaces. In FIG. 6, the opposite surfaces are the third end 46 and a wall perpendicular to the stairs.

In FIG. 6, the example threaded aperture 22 is adapted to receive the example threaded bolt 24 that has the example bolthead 26. The example threaded aperture 22 is in the example base 44 at the third end 46. The example threaded aperture 22 removably receives the example threaded bolt 24 that has the bolthead 26. The example bolthead 26 has the example bolthead bumper 28.

FIG. 7 illustrates a second perspective view of the example barrier 41 of the example second stair barrier system 40. The second perspective view of FIG. 7 illustrates a fourth end 48 of the example base 44, the fourth end 48 proximate to the example body portion 42. The fourth end 48 of the example base 44 includes the first bumper 30. In some examples, the first bumper 30 abuts an opposite surface relative to the surface that the bolthead bumper 28 abuts. In some examples, the first bumper 30 is a rubber bumper to prevent any damage the base 44 may cause on the opposite surface. Additionally and/or alternatively, the first bumper 30 may be made of any material that can protect a surface (e.g., a wall, glass, etc.) from scratches, holes, or any type of damage. The example first bumper 30 is affixed to the example base 44 via any fastening mechanism (e.g., nail, glue, epoxy, paste, etc.).

In FIG. 7, the example barrier 41 includes the second bumper 32. In this example, the second bumper 32 is an upper bumper affixed on an upper portion of the body portion 42. In some examples, the second bumper 32 is directly above first bumper 30. The example second bumper 32 is a rubber bumper to prevent any damage the body portion 42 may cause on the opposite surface. Additionally and/or alternatively, the second bumper 32 may be made of any material that can protect a surface (e.g., a wall, glass, etc.) from scratches, holes, or any type of damage. The example second bumper 32 is affixed to the body portion 42 via any fastening mechanism (e.g., nail, glue, epoxy, paste, etc.).

In one cycle of operation of this embodiment, an individual (e.g., a person) places the first and second barriers 11 on the plurality of stairs in a staggered, alternating manner. The individual extends the extending member 20 by turning the threaded bolt 24 that is removably received within the threaded aperture 22 to longitudinally extend the threaded bolt 24 out of the threaded aperture 22, thereby exerting the force on the pair of opposite surfaces perpendicular to the stairs through the bolthead bumper 28 and the first bumper 30. The second bumper 32 also contacts one of the opposite surfaces perpendicular to the stairs. The individual attaches the securing member 34 to the rail by wrapping a cord around the rail, for example.

In a second cycle of operation of this embodiment, an individual (e.g., a person) places the first and second barriers 41 on the plurality of stairs in a staggered, alternating manner. The individual extends the extending member 20 by turning the threaded bolt 24 that is removably received within the threaded aperture 22 to longitudinally extend the threaded bolt 24 out of the threaded aperture 22, thereby exerting the force on the pair of opposite surfaces perpendicular to the stairs through the bolthead bumper 28 and the first bumper 30. The second bumper 32 also contacts one of the opposite surfaces perpendicular to the stairs. The individual attaches the securing member 34 to the rail by wrapping a cord around the rail, for example. In some examples, the individual attaches the securing member 34 to the rail by clipping, snapping, tying, securing, pinning, or nailing the securing member 34 to the rail.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

From the foregoing, it will be appreciated that example systems, apparatus, articles of manufacture, and methods have been disclosed that improve the safety of ascending and descending stairs by reducing a length of a potential fall. For example, examples disclosed herein provide a pair and/or at least two or more pairs of barriers, having either a wedge shape or a rectangular block shape, that cover alternating halves of stairs. The barriers prevent dangerous human trajectories down a flight of stairs while also redirecting impacts to the human falling.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A stair barrier system configured for positioning on a staircase, the stair barrier system comprising:
first and second barriers, each barrier having a body portion, a base portion, and an adjustable member, wherein the adjustable member is adapted to exert a force on a side surface perpendicular to the staircase;
wherein each body portion has a body height greater than a body width, wherein each base portion includes a first end and a second end and has a base width greater than the body width; and
wherein the body portion of the first barrier is above the first end of the base portion, and wherein the body portion of the second barrier is above the second end of the base portion.

2. The stair barrier system of claim 1, wherein the adjustable member includes an aperture configured to removably receive an extendable insert adapted to exert the force on the side surface perpendicular to the staircase.

3. The stair barrier system of claim 2, further including:
a first bumper affixed to the extendable insert; and
a second bumper affixed to the second end of the base portion, wherein the second bumper exerts a force on a second side surface opposite from the side surface, the second side surface perpendicular to the staircase.

4. The stair barrier system of claim 1, further including a securing member adapted to attach the first and second barriers to respective rails on the staircase.

5. The stair barrier system of claim 4, wherein the securing member is at least one of a cord, a wire, a cable tie, or a hook and loop strap system.

6. The stair barrier system of claim 1, wherein each barrier has a front, inclined surface and a vertical back surface, the front surface and the back surface forming a wedge shape.

7. The stair barrier system of claim 6, wherein a widest portion of the wedge shape is at the bottom of each barrier.

8. A stair barrier system for improving safety while descending and ascending a staircase, the stair barrier system comprising:
a plurality of barriers staggered in an alternating manner on the staircase, each barrier having a body, a base, and an extending member, wherein the extending member is adapted to exert a force on a side surface perpendicular to the staircase;
a plurality of respective cords adapted to attach the plurality of barriers to respective rails of the staircase; and
wherein each body has a height greater than a body width, wherein each base includes a first end and a second end and has a base width greater than the body width;
wherein the body of at least one of the plurality of barriers is above the first end of the base of at the least one of the plurality of barriers, and wherein the body of at least a second one of the plurality of barriers is above the second end of the base of the second one of the plurality of barriers; and
wherein the extending member includes a threaded bolt secured within the base and a bolthead, the threaded bolt adapted to extend out of the base to exert a force on the side surface perpendicular to the staircase through the bolthead.

9. The stair barrier system of claim 8, wherein each of the plurality of barriers includes a bumper affixed at an upper portion of the body and positioned between the body and a second side surface perpendicular to the staircase.

10. The stair barrier system of claim 8, wherein each of the plurality of barriers have a front inclined surface and a vertical back surface, the front inclined surface and the vertical back surface forming a wedge shape.

11. The stair barrier system of claim 8, wherein the body and the base comprise of at least one of wood or metal.

12. A method of making a stair barrier system configured for positioning on a staircase, the method comprising:
placing a plurality of barriers staggered in an alternating manner on the staircase, the plurality of barriers having a body portion and a base portion, wherein a body width is less than a width of the staircase;
extending, using an adjustable member, the base portion horizontally to exert a force on a side surface perpendicular to the staircase; and
attaching, using a securing member, the plurality of barriers to respective rails of the staircase.

13. The method of making a stair barrier system of claim 12, wherein the adjustable member includes a threaded bolt secured within the base portion and a bolthead, the method further including turning the threaded bolt to extend the threaded bolt horizontally out of the base portion.
